(19) United States
(12) Patent Application Publication
(10) Pub. No.: US 2024/0253024 A1
(43) Pub. Date: Aug. 1, 2024

(54) CATALYST SYSTEM FOR POLYURETHANE FOAMS

(71) Applicant: The Johns Hopkins University, Baltimore, MD (US)

(72) Inventors: Steven W. Knowlden, Dayton, MD (US); Scott A. Shuler, Baltimore, MD (US); Hannah E. Collins, Columbia, MD (US)

(73) Assignee: The Johns Hopkins University, Baltimore, MD (US)

(21) Appl. No.: 18/421,314

(22) Filed: Jan. 24, 2024

Related U.S. Application Data
(60) Provisional application No. 63/482,110, filed on Jan. 30, 2023.

(51) Int. Cl. B01J 31/12; C08G 18/22; C08G 18/32

(52) U.S. Cl. CPC B01J 31/12; C08G 18/22; C08G 18/3203

(57) ABSTRACT

Disclosed herein is a safe and rapid reacting catalyst for polyurethane polymerization. Also disclosed herein is a method of producing the catalyst and polymerizing polyurethane. The combination of an organic polymerization initiator and an organometallic polymerization initiator leads to a safer alternative to tin-based materials.

### CROSS-REFERENCE TO RELATED APPLICATIONS

The present application claims priority to and filing benefit of U.S. Provisional Patent Application No. 63/482,110 filed on Jan. 30, 2023, which is incorporated herein by reference in its entirety.

### BACKGROUND

Polyurethane (PU) foams are a ubiquitous and long-standing commodity material. In some cases, polymer catalysts used in the polymerization can be toxic and time consuming. As PU foam use increases, so does the need for safe and rapid-reacting polymerization catalysts.

### SUMMARY

There exists a need for a safe and rapid reacting catalyst for polyurethane polymerization (or “catalyst compound”). The combination of an organic polymerization initiator and an organometallic polymerization initiator leads to a safer alternative to tin-based materials.

In some embodiments of the present disclosure, described herein is a catalyst compound including an organic compound and an organometallic compound. In some embodiments, the organic compound is a liquid at standard temperature (25° C.) and pressure (1 bar) (STP) and the organometallic compound is soluble in the organic compound (e.g., the organic compound is miscible with the organometallic compound). In some embodiments, the organic compound can be a solid and the catalyst compound can further include a solvent that is a good solvent for the organic compound and the organometallic compound. In some embodiments, the organic compound can be a free radical initiator and the organometallic compound includes a metal atom and one or more organic ligands covalently attached to the metal atom (e.g., a metal atom selected from any of Group IIIA, Group IVA, Group VA, Group VIA, Group VIIA, Group VIIIA, Group IB,

Group IIB, Group IIIB, Group IVB, Group VB, or Group VIB elements) and the one or more organic ligands can include a terminal free radical. In some embodiments, the catalyst includes up to 49% organic compound and/or at least 51% organometallic compound.

In other embodiments of the present disclosure, the catalyst compound includes an organic compound and an organometallic compound, wherein the organometallic compound makes up at least 51% of the catalyst compound. In some embodiments, the organic compound is a liquid at standard temperature and pressure (STP) and the organometallic compound is soluble in the organic compound. In some embodiments, the organic compound is a solid and the catalyst compound further includes a solvent that is a good solvent for the organic compound and the organometallic compound, and the organic compound is miscible with the organometallic compound. In some embodiments the organic compound comprises a free radical initiator.

A further embodiment of the present disclosure is directed to a method of providing a polyurethane foam, wherein the method includes providing a catalyst compound by combining an organic liquid compound with an organometallic compound (e.g., the organometallic compound is soluble in the organic liquid compound and the organometallic compound makes up at least 51% of the catalyst compound), adding the catalyst compound to a polyol solution, reacting the isocyanate solution with the catalyst compound in a condensation reaction, and stopping the condensation reaction.

Covered embodiments of the invention are defined by the claims, not this summary.

This summary is a high-level overview of various aspects of the invention and introduces some of the concepts that are further described in the Detailed Description section below.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

### BRIEF DESCRIPTION OF THE DRAWINGS

The accompanying drawings are incorporated herein and form a part of the specification.

FIG. 1 is a digital image showing various polymerization results according to some embodiments of the present disclosure.

In the drawings, like reference numbers generally indicate identical or similar elements.

### DETAILED DESCRIPTION

As used herein, the meaning of “a,” “an,” and “the” includes singular and plural references unless the context clearly dictates otherwise.

As used herein, the meaning of “room temperature” can include a temperature of from about 15° C. to about 30° C., for example about 15° C., about 16° C., about 17° C., about 18° C., about 19° C., about 20° C., about 21° C., about 22° C., about 23° C., about 24° C., about 25° C., about 26° C., about 27° C., about 28° C., about 29° C., or about 30° C.

All ranges disclosed herein are to be understood to encompass any and all endpoints as well as any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10.

The term “and/or” when used in a list of two or more items, means that any one of the listed items can be employed by itself or in combination with any one or more of the listed items. For example, the expression “A and/or B” is intended to mean either or both of A and B, i.e., A alone, B alone, or A and B in combination. The expression “A, B and/or C” is intended to mean A alone, B alone, C alone, A and B in combination, A and C in combination, B and C in combination or A, B, and C in combination.

The present disclosure is directed to polymer catalyst materials (e.g., polymer/polymerization initiators). In certain embodiments, the polymer catalyst material can have a significant impact on the polymerization rate of a polymer. For example, polyurethanes (PUs) are synthesized by a reaction between alcohols and isocyanates (e.g., compounds including R—N═C═O, or NCOs). Aromatic NCOs (e.g., toluene diisocyanate (TDI), methylene diphenyl diisocyanate (MDI), and the like) represent greater than 95% of the PU market, however aromatic NCOs are derived from petroleum and unsustainable. Conversely, aliphatic isocyanates (e.g., isophorone diisocyanate (IPDI)) are sustainable but slow to react (e.g., up to 700× slower than aromatic NCOs).

In some embodiments of the present disclosure, described herein is a catalyst compound including an organic compound (e.g., an organic liquid compound) and an organometallic compound. For example, the organic compound can be an organic superbase. In some embodiments, organic superbases can be organic amine superbases, which are organic materials containing nitrogen. In some embodiments, the organic amine superbases can exhibit a high basicity (e.g., having a pH greater than 9) and a high proton affinity due to the nitrogen in the compound. In some embodiments, organic superbases can include amidines, guanidines, phosphanes, and phosphazines. For example, an organic amine superbase can be 1,8-diazabicyclo[5.4.0]undec-7-ene (DBU), 1,5,7-triazabicyclo[4.4.0]dec-5-ene, 1,5diazacyclo[4.3.0]non-5-ene, 7-methyl-1,5,7-triazabicyclo[4.4.0]dec-5-ene, 1,4-diazabicyclo[2.2.2]octane, 1,1,3,3-tetramethylgaunidine, N,N-diisopropylethylamine, 2-tert-butyl-1,1,3,3-tetramethylguanidine, and/or trimethylamine.

In some embodiments, the organic compound is a liquid at standard temperature and pressure (STP) and the organometallic compound is soluble in the organic compound (e.g., the organic compound is miscible with the organometallic compound). For example, the organometallic compound can be added to the organic liquid compound and dissolve, disperse, mix, or otherwise stabilize within the organic liquid compound. In some embodiments, mixing the organic liquid compound with the organometallic compound in solvent provides a stable, turbid solution prior to polymerization with the isocyanate compound (e.g., the isocyanate solution). In some embodiments, the organic liquid compound and the organometallic compound can be mixed into a polyol.

In some embodiments, the organic compound can be a solid and the catalyst compound further comprises a solvent that is a good solvent for the organic compound and the organometallic compound. As used herein, a good solvent includes physiochemical characteristics that, when a solute is dissolved in the good solvent, the solute does not settle out of solution (e.g., “crash out”). For example, a good solvent can be chemically inert with respect to the solute, have a dielectric constant suitable to dissolve ionic compounds, have a low vapor pressure such that the good solvent is not volatile at room temperature, and the good solvent can have a permanent dipole moment (e.g., the good solvent is non-polar).

In some embodiments, the organic compound can be a free radical initiator. In some embodiments, the free radical initiator is DBU. Not to be bound by theory, the DBU initiator and the organometallic compound in the polyol solution can react with the isocyanate in a condensation polymerization, providing the polyurethane molecule. In some embodiments, water in the solution can react with the isocyanates to initiate the foam formation from carbon dioxide released during the polymerization.

In some embodiments, the organometallic compound includes a metal atom and one or more organic ligands covalently attached to the metal atom (e.g., a metal atom selected from any of Group IIIA, Group IVA, Group VA, Group VIA, Group VIIA, Group VIIIA, Group IB, Group IIB, Group IIIB, Group IVB, Group VB, or Group VIB elements).

In some embodiments, the one or more organic ligands can be a terminal free radical, a terminal cation, or a terminal anion. For example, the metal atom can be any one of scandium (Sc), titanium (Ti), zirconium (Zr), vanadium (V), niobium (Nb), tantalum (Ta), chromium (Cr), molybdenum (Mo), tungsten (W), manganese (Mn), iron (Fe), cobalt (Co), nickel (Ni), palladium (Pd), platinum (Pt), copper (Cu), silver (Ag), gold (Au), zinc (Zn), cadmium (Cd), aluminum (Al), indium (In), tin (Sn), antimony (Sb), bismuth (Bi), selenium (Se), or tellurium (Te).

In some embodiments, the organometallic compound can be a Ti-based compound. For example, the organometallic compound can be diisopropoxy-bis(ethylacetoacetato)titanate, or Ti(IV) 2-ethylhexanoate. In some embodiments, using a non-toxic titanium-based organometallic compound in tandem with an organic amine superbase as a catalyst compound to polymerize aliphatic isocyanates provides a rapid and tunable polymerization reaction. In some embodiments, the polymerization can occur in less than one minute (e.g., about 10 seconds, about 15 seconds, about 30 seconds, about 45 seconds, or about 59 seconds). In additional embodiments, the polymerization can occur at a temperature of about room temperature (e.g., from about 15° C. to about 30° C.). In some embodiments, the polymerization employing a catalyst compound including DBU and Ti(IV) 2-ethylhexanoate can react with an aliphatic isocyanate to provide a PU foam in less than one minute at room temperature.

In some embodiments, the catalyst compound can be used to tune the mechanical properties of the PU foam. For example, the density of the catalyst compound can be tailored to provide PU foams having varying cell structures that provide varying foam rigidity. In some embodiments, the catalyst compound can include a solids content (e.g., the density of the catalyst compound in solution) ranging from 0.5 wt.-% to 20 wt.-% (e.g., from 1 wt.-% to 15 wt.-%, from 0.5 wt.-% to 19 wt.-%, from 1.5 wt.-% to 20 wt.-%, from 2 wt.-% to 15 wt.-%, or from 1 wt.-% to 19 wt.-%). For example, when the solids content of the catalyst compound is up to about 5 wt.-% with respect to the isocyanate in the reaction solution, the PU foam can be a more flexible (e.g., less rigid) material. Conversely, when the solids content of the catalyst compound is greater than about 10 wt.-%, the PU foam can be a more rigid material.

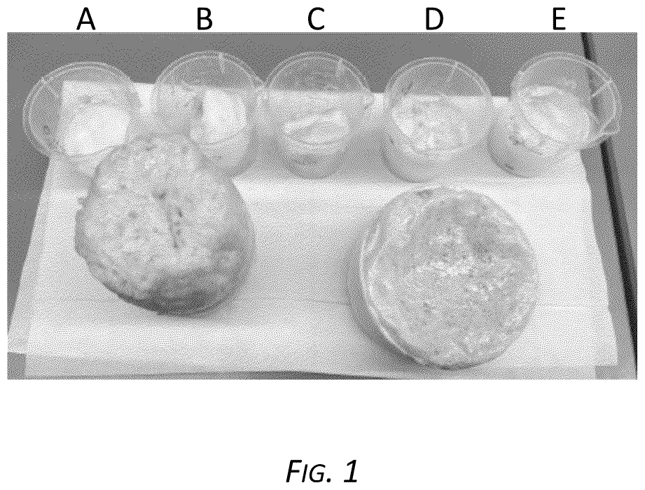

FIG. 1 is a digital image showing PU foams having varied rigidity according to the solids loading of the catalyst compound. In some embodiments, by varying the solids content of the catalyst compound (e.g., the density of the catalyst compound in solution), the rigidity of the PU foam can be tuned to a desired rigidity. As shown in the example of FIG. 1, the foam on the left side of the image were prepared using a higher catalyst compound concentration with respect to the isocyanate in the reaction solution, providing a less rigid (e.g., more flexible) PU foam. The foam on the right side of the image was prepared using a lower catalyst compound concentration with respect to the isocyanate in the reaction solution, providing a rigid PU foam. Also shown in FIG. 1 is a rigidity gradient provided by varying the concentration of the catalyst compound during aliphatic isocyanate polymerization. In the smaller beakers shown in FIG. 1, the rigidity of the foams increases from left to right. For example, beaker A contains a flexible foam and beaker B contains a foam that is more rigid than the foam in beaker A. Beaker C contains a foam that is more rigid than the foam in beaker B. Beaker D contains a foam that is more rigid than the foam in beaker C. Finally, beaker E contains a foam that is more rigid than the foam in beaker D. In some embodiments, the catalyst compound described herein can provide rigidity-tunable PU foams.

In some embodiments, the catalyst compound includes up to 49% organic compound and/or at least 51% organometallic compound. For example, the catalyst compound can include about 5%, about 10%, about 15%, about 20%, about 25%, about 30%, about 35%, about 40%, about 41%, about 42%, about 43%, about 44%, about 45% , about 46%, about 47%, about 48%, or about 49% organic compound by weight. Likewise, the catalyst compound can include about 50%, about 51%, about 52%, about 53%, about 54%, about 55%, about 56%, about 57%, about 58%, about 59%, about 60% , about 65%, about 70%, about 75%, about 80%, or about 85% organometallic compound by weight. For example, the catalyst compound can include the organometallic compound at least 1 wt.-% to 2 wt.-% greater than the organic compound.

Additionally, the catalyst compound can be expressed as a ratio of the organic compound to the organometallic compound. In some embodiments, the catalyst compound can include a ratio of the organic compound to the organometallic compound of about 49:51. In some embodiments, the ratio of the organic compound to the organometallic compound can be about 48:52, about 47:53, about 46:54, about 45:55, about 44:56, about 43:57, about 42:58, about 41:59, or about 4:5.

A further embodiment of the present disclosure is directed to a method of providing a polyurethane foam, wherein the method comprises providing a catalyst compound by combining an organic liquid compound with an organometallic compound (e.g., the organometallic compound is soluble in the organic liquid compound and the organometallic compound makes up at least 51% of the catalyst compound). In some embodiments, the catalyst compound can include about 51% of the organometallic compound (e.g., Ti(IV) 2-ethylhexanoate) and about 49% of the organic compound (e.g., DBU).

In some embodiments, the method can also include adding the catalyst compound to an isocyanate solution at room temperature. In some embodiments, the catalyst compound can be loaded into a reaction vessel with the aliphatic isocyanate compound at a solids content for the catalyst compound of from about 0.5 wt.-% to about 20 wt.-%, depending on the desired rigidity as described above.

In some embodiments, the method can further include reacting the isocyanate solution with the catalyst compound in a condensation reaction. For example, the catalyst compounds in the presence of the aliphatic isocyanate in solution will begin to polymerize as the isocyanate reacts with hydroxyl groups in the polyol.

In some embodiments, the method can further include stopping the condensation reaction (e.g., the polymerization of the aliphatic isocyanate). Stopping the polymerization can be performed by controlling the volume and/or density of the catalyst compound such that the polymerization self-exhausts. In some embodiments, the polymerization can be stopped by a rapid temperature change (e.g., rapid cooling).

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A catalyst compound, comprising:
an organic compound; and
an organometallic compound.

2. The catalyst compound of claim 1, wherein the organic compound is a liquid at standard temperature and pressure (STP).

3. The catalyst compound of claim 2, wherein the organometallic compound is soluble in the organic compound.

4. The catalyst compound of claim 1, wherein the catalyst compound further comprises a solvent when the organic compound is a solid.

5. The catalyst compound of claim 4, wherein the solvent is a good solvent for the organic compound and the organometallic compound.

6. The catalyst compound of claim 5, wherein, when in solution, the organic compound is miscible with the organometallic compound.

7. The catalyst compound of claim 1, wherein the organic compound comprises a free radical initiator.

8. The catalyst compound of claim 1, wherein the organometallic compound comprises:
a metal atom; and
one or more organic ligands covalently attached to the metal atom.

9. The catalyst compound of claim 8, wherein the metal atom comprises a metal atom selected from any of Group IIIA, Group IVA, Group VA, Group VIA, Group VIIA, Group VIIIA, Group IB, Group IIB, Group IIIB, Group IVB, Group VB, or Group VIB elements.

10. The catalyst compound of claim 8, wherein the one or more organic ligands comprises a terminal free radical.

11. The catalyst compound of claim 1, comprising up to 49% organic compound.

12. The catalyst compound of claim 1, comprising at least 51% organometallic compound.

13. A catalyst compound, comprising:
an organic compound; and
an organometallic compound, wherein the organometallic compound comprises at least 51% of the catalyst compound.

14. The catalyst compound of claim 13, wherein the organic compound is a liquid at standard temperature and pressure (STP).

15. The catalyst compound of claim 14, wherein the organometallic compound is soluble in the organic compound.

16. The catalyst compound of claim 13, wherein the catalyst compound further comprises a solvent when the organic compound is a solid.

17. The catalyst compound of claim 16, wherein the solvent is a good solvent for the organic compound and the organometallic compound.

18. The catalyst compound of claim 17, wherein, when in solution, the organic compound is miscible with the organometallic compound.

19. The catalyst compound of claim 13, wherein the organic compound comprises a free radical initiator.

20. A method of providing a polyurethane foam, comprising:
providing a catalyst compound by combining an organic liquid compound with an organometallic compound, wherein the organometallic compound is soluble in the organic liquid compound, and wherein the organometallic compound comprises at least 51% of the catalyst compound;
adding the catalyst compound to a polyol solution;
reacting the isocyanate solution with the catalyst compound in a condensation reaction; and
stopping the condensation reaction.
